(19) United States
(12) Patent Application Publication
(10) Pub. No.: US 2009/0101529 A1
(43) Pub. Date: Apr. 23, 2009

(54) Disc tray and board package

(75) Inventors: Paul J. Gelardi, Cape Porpoise, ME (US); Anthony L. Gelardi, Strong, ME (US); Pepin S. Gelardi, Cape Porpoise, ME (US)

Correspondence Address: JAMES C. WRAY, 1493 CHAIN BRIDGE ROAD, SUITE 300, MCLEAN, VA, 22101, US

(73) Assignee: SunLyte LLC

(21) Appl. No.: 12/215,433

(22) Filed: Jun. 27, 2008

Related U.S. Application Data
(60) Provisional application No. 60/999,922, filed on Oct. 22, 2007.

(51) Int. Cl. B65D 85/57; B26D 7/27

(52) U.S. Cl. 206/308.1; 53/396

(57) ABSTRACT

Beverage and water bottles are recycled by flaking and melting, extruding thin RPET thermoplastic sheets thermoforming disc and product trays. The thermoformed trays have disc or product receiving wells surrounded by inner walls. Tray outer walls are surrounded by flanges to aid in separation of stacked trays before joining the trays and covers. Disc trays have resiliently deformable hubs with radially extending retaining bumps formed during or after thermoforming the trays. Product trays have similar product-retaining thermoformed bumps projected over product wells. Paperboard covers are printed outside and inside, clear coated, creased to form spines and adhered to trays with minimal, separable adhesive for recycling ease. Gutters are adhered to inner portions of spaced trays forming flexible hinges, films are attached to flanges at remote edges of tray and printed inserts are inserted between the films and trays when loading the trays and before closing the packages.

This application claims the benefit of U.S. Provisional Application No. 60/999,922, filed Oct. 22, 2007, which is hereby incorporated by reference in its entirety.

### SUMMARY OF THE INVENTION

The SunLyte Disc Package is a composite package made from thermoformed plastic and printed paperboard in several sizes to serve the CD, DVD, HD and BluRay disc markets as well as for packaging other goods. The new SunLyte tray is made from polyethylene terephalate (PET), PVC, PLA or other plastic material. The thermoformed tray is made of recycled PET (RPET) or PET. Preferably, it is made from 100% recycled PET, known as RPET, with post consumer recycled content from beverage bottles. Using PET provides the package with enhanced flexibility and destruction, deformation, tear and impact resistance. Using RPET with post consumer content from soda, soft drink, beverage and water bottles provides environmental advantages. In the process of the invention the soda, soft drink, beverage and water bottles are comminuted, ground, milled or hammered into RPET flakes. The flakes are melted, and the melt is extruded into sheets, which are divided and thermoformed as trays.

A key feature that makes this composite disc package different and successful is that the tray is made by thermoforming. Other composite board and plastic disc packages utilize injection molded trays.

The invention includes the tray, the RPET tray, the combined paperboard or soft cover and tray package and the processes of flaking, melting and extruding the RPET and making the tray and the package.

Advantages of the tray and package include:
compliant yet robust disc holding feature,
tapered recess in the center hub center for accurate location of the tray when discs are assembled by automation and adhesion of hub to the paperboard,
rim around the outside of the tray beyond the outside vertical walls to allow for ease of separating individual trays from a stack in destacking and placement automation, and
direct contact of the tray bottom surface with the board increases contact clarity and improves the appearance of any printed graphics.
interference fit of the center undercut features hub limits tray nesting and creates tray spacing for easier tray separation.

The process includes:
grinding and cleaning plastic bottles into flake
melting the flake and reforming the melted plastic into pellets
melting plastics pellets and/or flake and extruding them into sheet,
forming the sheet into trays using molds, heat, vacuum, and/or pressure,
forming a raised structure to protect the disc within the space created by the cardboard jacket,
forming the compliant disc, or other product, holding feature by molding a negative undercut form and elastically stretching the plastic to remove it from the undercut form,
die-cutting the formed tray from the sheet,
printing cardboard,
coating of the printed board with a clear coating,
die-cutting the cardboard into an outer wrap-around jacket,
gluing and folding the printed cardboard to form a double thick jacket,
adhering one or more thermoformed trays to the printed jacket,
use of a tack adhesive to adhere the trays to the printed jacket but that adhere better to the plastic tray than the optional clear coating on the board thereby allowing the tray to be removed from the printed board for recycling.

The thinness of the plastic that is able to be achieved by extrusion and thermoforming is ⅓ of what could be achieved by injection molding, offering great material savings and a greatly reduced package thickness. The reduction of material used and the separating recycling of the components are advantages of the new tray and package.

The present invention is an eco-effective package called the SunLyte tray. The tray is thermoformed from 0.012 inch sheet. The formed height of the tray can be varied to allow many different packaging configurations. All necessary CD tray features are integrated into this tray design including a new disc, or other product, retention features.

The recess in the hub is used in conjunction with a pilot pin as a centering system for disc placement in disc loading automation. The bottom recess of the center hub is also designed to allow the hub to be secured to the board. The rim around the edge of the tray aids in separating the stacked trays during destacking and positioning automation. The tray is adhered to the board by glue or heat sealing. Center hub undercuts are formed in the thermoforming molds.

The center hub is formed with one or more disc retaining bumps that have sloped tapered upper sides to provide centering when loading discs with automation or by hand. Sloped lower sides permit removal of a disc from a tray. The tapers or slopes permit elastic distortion of the bumps and the center hub post to permit passage of the disc.

There are four ways to form the bumps on the center hub:

The material is formed over a male form that has the bumps on its outer surface. The formed tray part is pulled off the male form. The material must stretch somewhat to be released from the male form. The size of the bumps is equal to the size of the bumps on the male form plus the thickness of the formed sheet, less material shrinkage due to the change in material temperature from the forming temperature to ambient temperature.

The material is also formed on a female form that has the bumps in relief on its internal surface. The part is pulled off the main female form. The material must compress somewhat to be released from the female form undercut. The size of the bumps is equal to the size of the bumps in the female form, less material shrinkage due to the change in material temperature from the forming temperature to the ambient temperature. There are advantages and disadvantages to both techniques. The ultimate choice is made based upon the rest of the parts design, the mold and the thermoforming equipment that is being used.

A male form with retractable features can also be used. After the forming of the bumps is completed, the features are retracted, allowing the removal of the mold undercuts.

The bumps can be added after thermoforming by mechanically cold forming or hot forming the center hub with a tool. The size of the bumps is dependent upon the amount of mechanical deformation applied.

A disc retention feature has a thermoformed boss with multiple nubs around the outer rim formed with undercuts. The inside has a recess that adds structural strength, assists in flexibility and is useful for centering the tray during board and disc insertion.

The invention includes the tray, hubs, covers and the entire process. That is, a package having a board with an attached glued, heat sealed or mechanically attached thermoformed tray with a disc retention feature. The tray includes the central hub that allows centering, as well as the outside rim/flange that allows for separation and positioning.

The invention provides a package for holding one or more discs or other products in one or more thermoformed trays with product retention features adhered to a paperboard cover. The cover is configured to hold one or more trays and has two or more creases to allow the cover to be folded closed, or to be opened flat. The thermoformed tray package for holding discs and other products is made from recycled PET from beverage bottles. One or more features formed into the thermoformed tray by undercuts that hold discs or other products in the tray.

Holding features of the thermoformed tray are formed over a male form that has one or more bumps on its outer surface. The formed tray part is pulled off the male form. The material must stretch somewhat to be released from the male form. The size of the bumps is equal to the size of the bumps on the male form plus the thickness of the formed sheet, less material shrinkage due to the change in material temperature from the forming temperature to ambient temperature.

Holding features also are created by forming into a female form that has the bumps in relief on its internal surface. The part is pulled off the main male form. The material must compress somewhat to be released from the female form undercut. The size of the bumps is equal to the size of the bumps in the female form, less material shrinkage due to the change in material temperature from the forming temperature to the ambient temperature.

Holding features also are formed over a male form with retractable features. After forming of the bumps is completed, the features are retracted allowing the removal of the mold undercuts.

Holding features also are created by mechanically cold forming or hot forming the center hub with a tool. The size of the bumps is dependent upon the amount of mechanical deformation applied.

A thermoformed tray with a flange projecting outward from the side of the tray allows easy separation of the trays when nested in stacks of two or more trays.

A thermoformed tray with a raised center hub or other product holding shape has one or more protrusions to limit the distance the trays can nest when stacked.

In making a package, paperboard is printed, cut, folded and creased to create package covers. An extruded plastic sheet is heated and formed into product holding trays, and one or more product holding trays are adhered to the printed paperboard covers. The paperboard cover can be opened flat or folded into a closed package.

For making a package, beverage bottles made from PET are cleaned, ground and extruded into thin rolls of sheet film. The sheet film is cut and thermoformed into trays for holding discs and other products using product retention features.

One of the most important characteristics of PET is referred to as I.V. (intrinsic viscosity).

The I.V. of the material, measured in deciliters per gram (dl/g), is dependent upon the length of its polymer chains. The longer the chains, the stiffer the material, and therefore the higher the I.V. “Higher I.V. materials have better impact strength.

The I.V. of PET varies according to the application. PET used for fiber has an I.V. of approximately 0.6 dl/g. PET used for film has an I.V. of approximately 0.65 dl/g. PET used for bottles has an I.V. ranging from 0.72 to 0.84 dl/g. Fiber grade PET's represent approximately 70% of the total PET market.

Each time PET is processed it looses roughly 0.03 dl/g of it's intrinsic viscosity.

The ideal I.V. for making SunLyte trays is with film with an I.V. of at least 0.7 dl/g and ideally 0.72 dl/g or greater. An I.V. of at least 0.7 dl/g imparts enough stiffness and impact resistance for the both the thermoforming process and the end use application.

Post consumer and post industrial recycled PET comes from a wide variety of source material including fiber, film and bottles. Since it is processed multiple times, recycled PET typically has an I.V. less than 0.7 dl/g. Beverage bottles are made from PET with an I.V. of 0.72 to 0.84 dl/g. It is preferable to include enough PET from recycled bottles to raise the I.V. above 0.7 dl/g. Large bottles are made from PET with I.V. Of 0.8 to 0.84 dl/g. Recycled PET for trays should contain enough PET from recycled PET from bottles to raise the I.V. above 0.7 dl/g. The amount required will vary based upon the mix of recycled materials. A minimum of 10% recycled bottle PET content is important. Trays made from 100% recycled PET from bottles provides the best results.

These and further and other objects and features of the invention are apparent in the disclosure, which includes the above and ongoing written specification, with the claims and the drawings.

### BRIEF DESCRIPTION OF THE DRAWINGS

FIG. 1 is a perspective view of a thermoformed RPET tray.

FIG. 2 is a plan view of the tray shown in FIG. 1.

FIG. 3 is an elevational cross section of the tray taken along B-B of FIG. 2.

FIG. 4 is a cross-section detail of a central portion of the tray in an area of circle A on FIG. 3, showing one of the sloped or tapered bumps that form the center hub.

FIG. 5 is a plan view detail of the central portion of the tray shown in FIG. 4.

FIG. 6 is an exploded view of a tray being assembled on a cardboard package cover.

FIG. 7 is an assembled view of a tray and cardboard package shown in FIG. 6.

FIG. 8 is a perspective closed view of the tray and package shown in FIGS. 6 and 7.

FIGS. 9, 10 and 11 are end, plan and side views of a folded five-tray package.

FIGS. 12, 13 and 14 are end, plan and side views of a folded six-tray package.

FIGS. 15 and 16 show developmental views of the cardboard for the package shown in FIGS. 6, 7 and 8.

FIG. 17 shows stacked trays.

FIG. 18 is a plan view of stacked trays.

FIG. 19 is a vertical cross section through line B-B of FIG. 18.

FIG. 20 shows a push-button rosette.

FIG. 21 is a side view of the push-button rosette shown in FIG. 20.

FIG. 22 is a plan view of the push-button rosette shown in FIGS. 20 and 21.

FIG. 23 is a vertical cross section through line B-B of FIG. 22, showing the operation of pushing the rosette to lift the disc.

FIG. 24 is a vertical cross section through line B-B of FIG. 22 showing movement of the disc.

FIG. 25 is a detail of a part holding tray on a creased paperboard cover also attached to a partial view of a disc holding tray.

FIG. 26 is a plan view of the cover and thermoformed booklet holder tray of FIG. 25.

FIG. 27 is a plan view of a thermoformed disc holding tray.

FIG. 28 is a vertical sectional view taken along line A-A of FIG. 27.

FIG. 29 is a vertical sectional detail taken along circle B of FIG. 28 showing attachment of the tray to a cover.

FIG. 30 is a schematic representation of folding and securing a four panel creased blank and attaching disc holding tray.

FIG. 31 is a plan view and perspective view of an assembled tray and folded panel board cover as shown in FIG. 30.

FIG. 32 is a plan view of the assembled tray with a folded panel board cover and a glue dot for closure.

FIG. 33 is a perspective view of the assembled tray with a folded panel board cover and the glue dot for closure.

FIG. 34 is a plan view of the assembled tray with folded panel board cover and a snap for closure.

FIG. 35 is a perspective view of the assembled tray with folded panel board cover and a snap for closure.

FIG. 36 is a detail of the snap where it connects to the tray.

FIG. 37 is a perspective view of an open panel-board cover with two trays attached.

FIG. 38 is a perspective view of an open panel board cover with a literature holding tray with literature clips attached to a printed board panel.

FIG. 39 is a perspective view of the package shown in FIG. 37 or 38 in a closed position.

FIG. 40 is a perspective view of a package as shown in FIG. 38 with an attached film and graphic insert, in an open position.

FIG. 41 is a perspective view of a package with an attached film and graphic insert as shown in FIG. 40, in a closed position.

FIG. 42 is a perspective view of a closed tray assembly with a film attached in place of a board.

FIG. 43 is a perspective view of the open tray assembly shown in FIG. 42 with a film attached in place of a board.

### DETAILED DESCRIPTION OF THE DRAWINGS

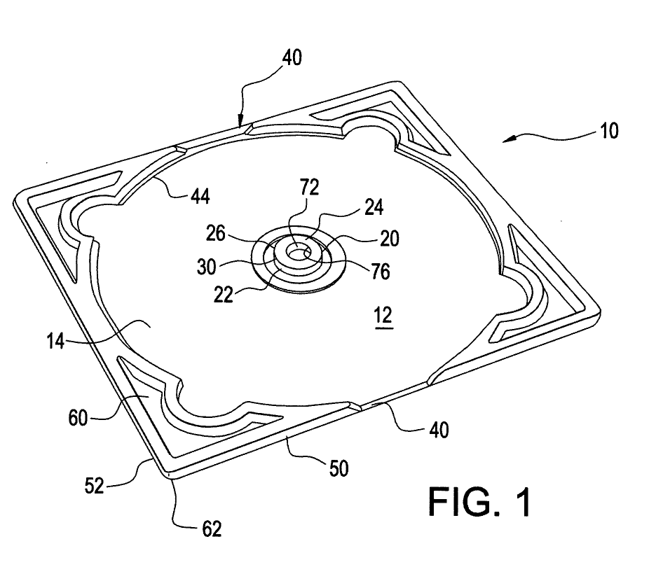

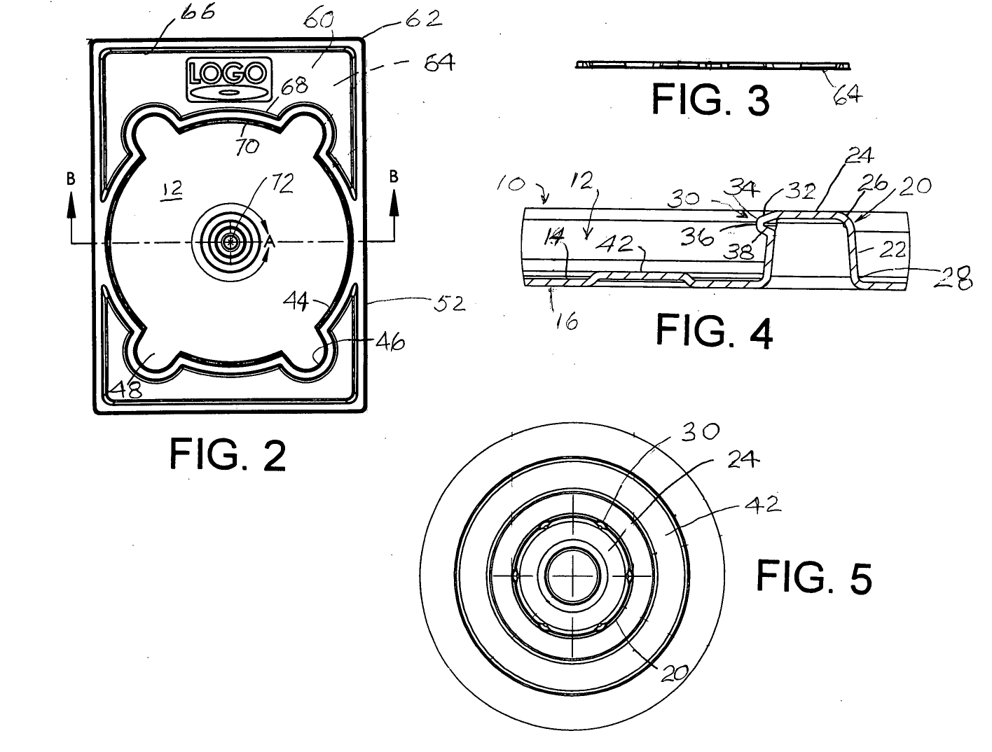

Referring to FIGS. 1-5 a thin tray 10 is thermoformed from an extruded RPET or other plastic sheet approximately 0.012 inches thick. The tray has a central disc receiver 12 with a flat bottom 14 having a base 16 which lies flat with the bottom 18 of the tray. A central center hub post 20 has a slight tapered side 22 and a top 24 with a radiused encircling edge 26.

One or more sloped and rounded disc-holding retainer bumps 30 extend outward from the radiused edge 26 to hold a disc in the tray 10.

The bumps 30 have sloped upper surfaces 32 to provide a centering of a disc during loading by automation or when replacing a disc in the tray 10. The rounded upper and lower edges 34 of the short cylindrical wall 36 allow inward elastic deformation and outward snapping of the bumps 30 to override the bumps when a disc is loaded in or removed from the tray and to snap back into outward positions when the disc has passed over the bumps. The sloped lower walls 38 of the bumps hold a disc in the tray and provide ease of disc removal by gently increasing inward flexture of the bumps 30 and wall 22 of the center hub post 20.

The raised shelf 42 is formed a short distance from the base 28 of the center hub post 20 to hold a disc upward, spaced from the flat bottom 14 of the disc receiver 12. Interrupted circular outer rib 44 serves the same purpose to space the outer periphery of the disc upward and thereby space the recorded surface of the disc upward above the bottom 14 of receiver 12.

Finger wells 46 have flat lower surfaces 48 so that the discs may be held upward by their thin outer edges when inserting, removing or storing the discs. Bottom sides of the lower surfaces 48 may be used to tack the tray to the printed cardboard.

The raised outer rib 44 does not extend into the finger wells 46, but does extend outward through the side openings 40 to the side walls 50 of the tray 10 for supporting the disc edge.

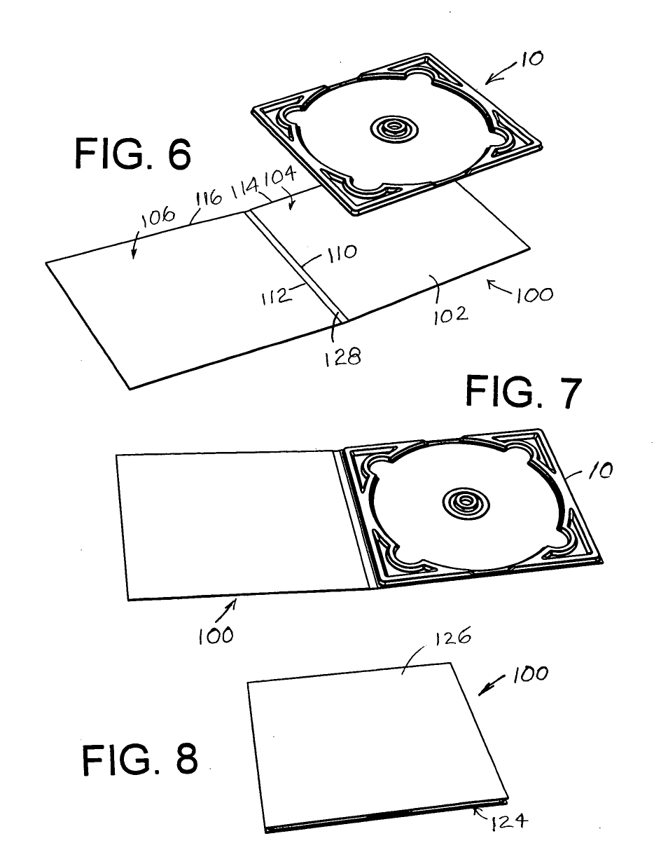

The outer side walls 50 are sloped upward and inward away from the rim 52 that extends outward around the base 54 of the side walls. The rim assists destacking of stacked trays with automation and assists alignment of trays 10 on the boards 100 shown in FIGS. 6 and 7,

Outer recesses 60 are formed in corners 62 of the tray 10 to provide flat bottom 64 for lying on the boards 100. The recesses have sloped walls 66 which provide stability to the side walls 50 near the corners 60 and which strengthen the walls 68 of the finger wells 46 and adjacent wall segments 70 of the receiver 12. The arrangement of the walls and outer recesses and the rib and rim provide stability to the tray.

The central recess 72 in the top 24 of the center hub post 20 has inward and downward tapering inner wall 76 to receive an alignment post of the automation machine when loading discs into the trays.

In some embodiments of the tray as shown in FIG. 1 the receiver walls 12 are connected to the outer side walls 50.

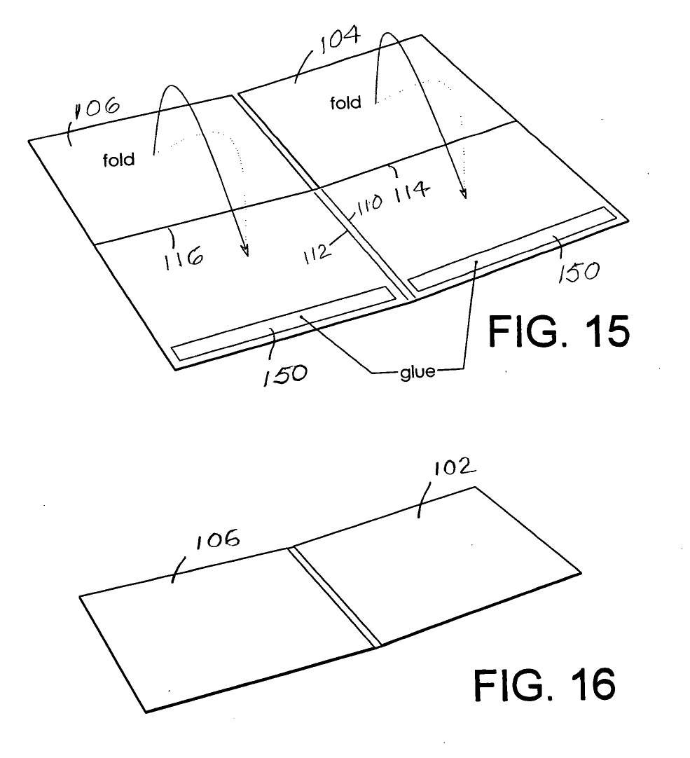

FIG. 6 shows a tray 10 being placed on a face 102 of a board 100. FIGS. 15 and 16 show a board 100 is formed from an elongated blank having four folds 110, 112, 114 and 116. End panels 104 and 106 are folded inward along folds 114 and 116 and glued to outer panels 124 and 126. The outer panels have inward folds 110 and 112, which form from the spine 128 between the folds 110 and 112. A double walled cardboard holder 100 results. Glue strips 150 are shown in FIG. 15.

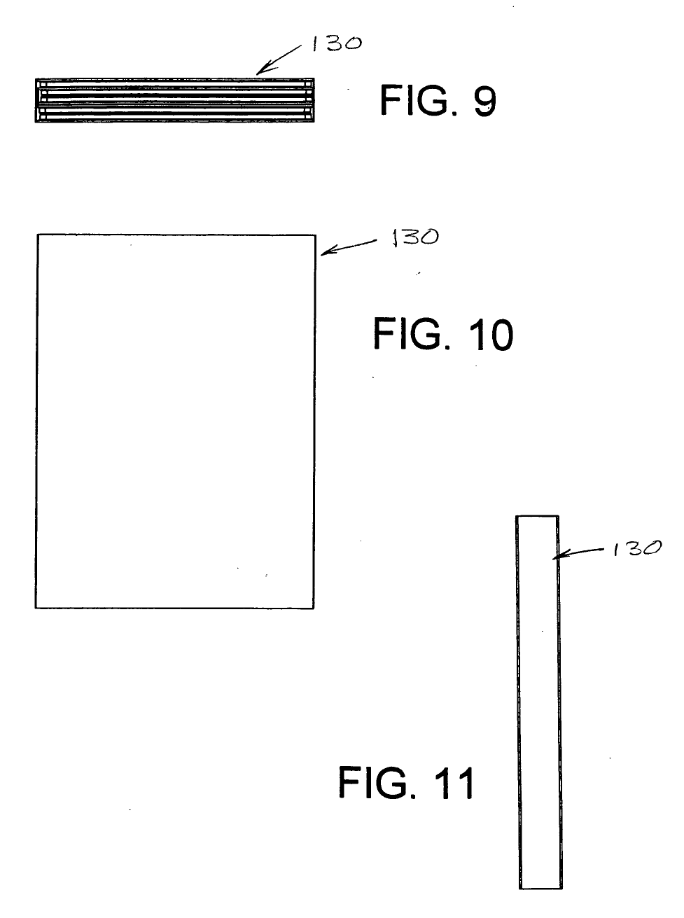

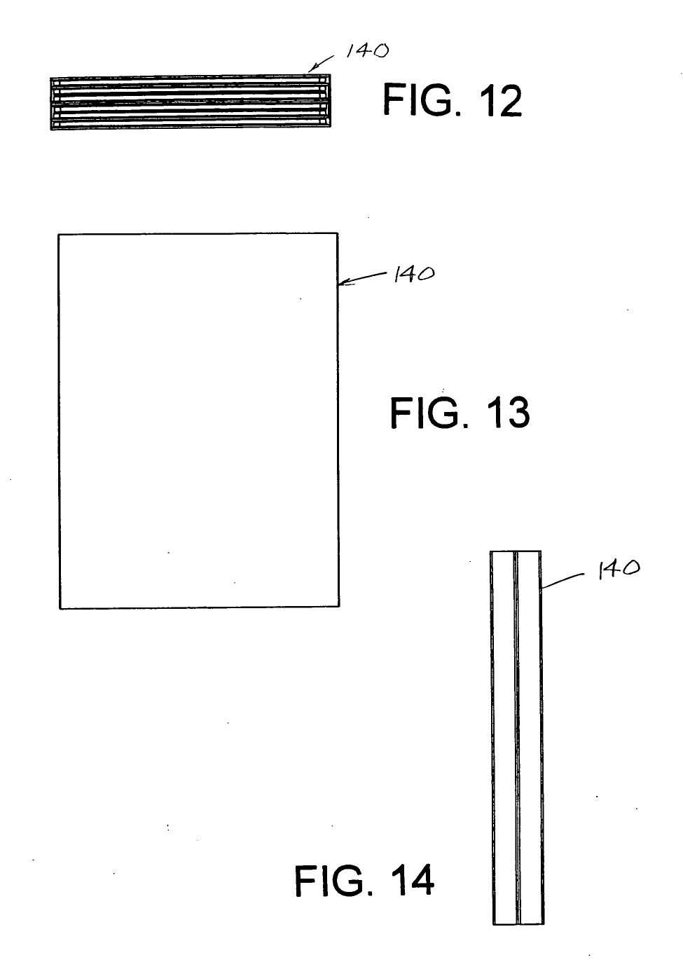

FIGS. 9, 10 and 11 show five-tray holders 130 which are formed of five double panels folded together in the same way as the two double panels of FIGS. 6, 15 and 16. FIGS. 12, 13 and 14 show six-tray holders 140 which are formed of six double panels folded together in the same way as the two double panels of FIGS. 6, 15 and 16.

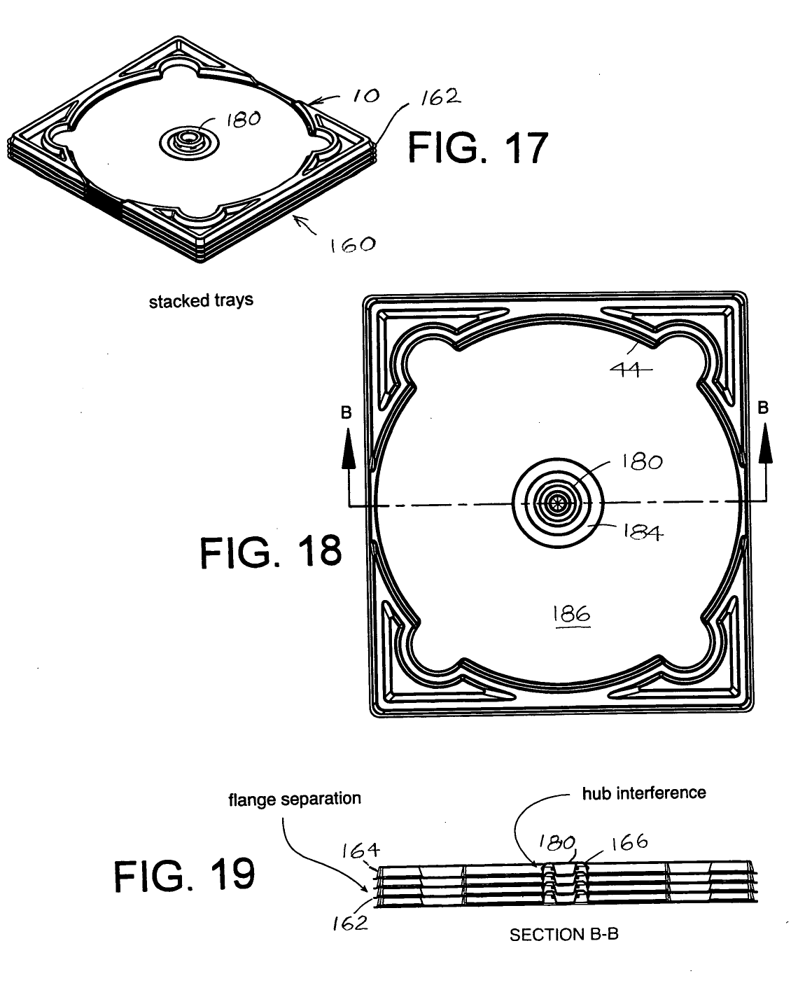

As shown in FIGS. 17-19, the thin thermoformed trays 10 are stacked 160 before use. Flanges 162 are formed around the trays to aid in unstacking the trays by a picking and placing machine or by hand.

Outer surfaces 164 of the trays are sloped for nesting and interference to hold the trays stacked until intentionally separated. Sloped edges 166 of the hubs 180 are sloped to provide interference to hold the stack together.

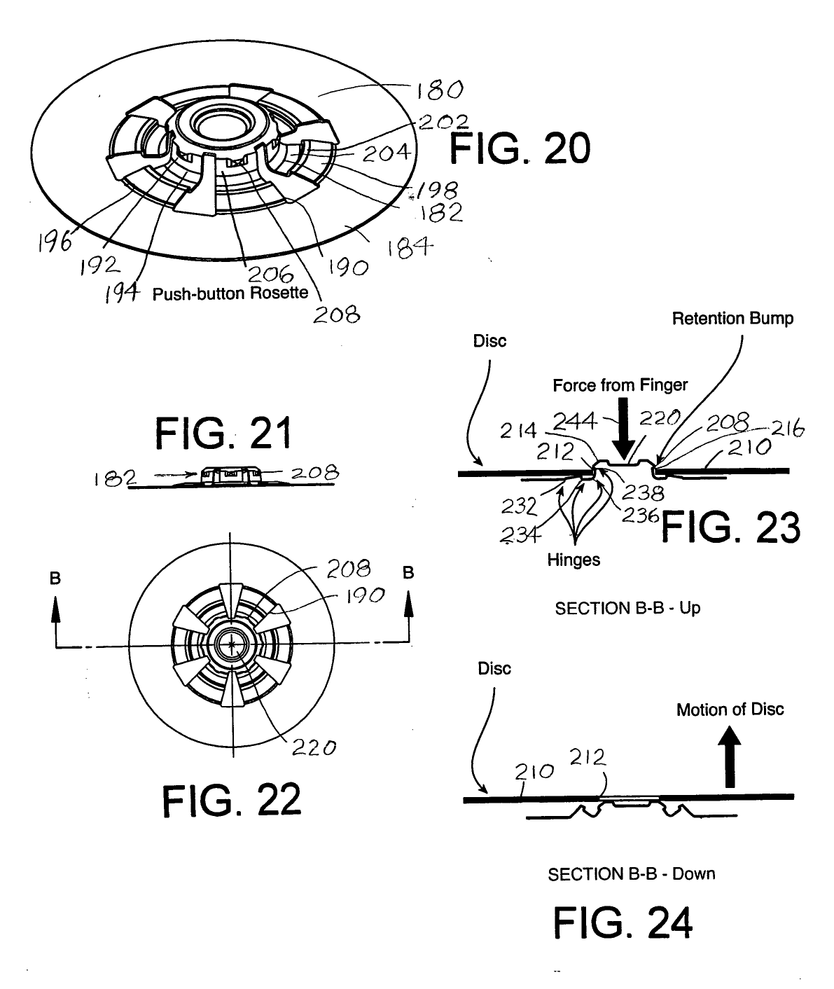

The hubs 180 integrally form push-button rosettes 182, as shown in FIGS. 20-24.

The hubs 180 have surrounding a raised surface 184 which cooperates with the raised outer rib 44 to hold the base of a disc spaced upward from the bottom 186 of the tray.

Sectoral openings 190 are formed in the tray to provide flexibility to the holding members 192 of the rosette 182. The holding members have bases 194 connected to and slightly depressed from the inner edge 196 of the raised surface 4. Upward sloping surfaces 198 lead to curved apexes 202 which press a center of a disc upward. Depressed areas 204 lie inward of the curved apexes 202. Vertical wall segments 206 of the rosette 182 are separated by inward extensions of the openings 190. Small retention bumps 208 at the top of the walls hold center openings 212 of discs 210 on the tray. Upper surfaces 214 and lower surfaces 216 of bumps 208 are sloped to aid in alignment of the disc opening 212 and to move the bumps 208 inward when placing a disc 210 in the tray 10. Rosette 192 has a flat upper surface 220 surrounded by a raised surface 222.

Hinges 232, 234, 236, and 238 are formed between adjacent surfaces to allow bending of the rosette, as shown in FIG. 23, when finger force 244 is applied to the center surface 220 as shown in FIG. 23. As finger force is applied to distort the rosette, a thumb and another finger grasp opposed outer edge portions of the disc to lift the disc from the tray.

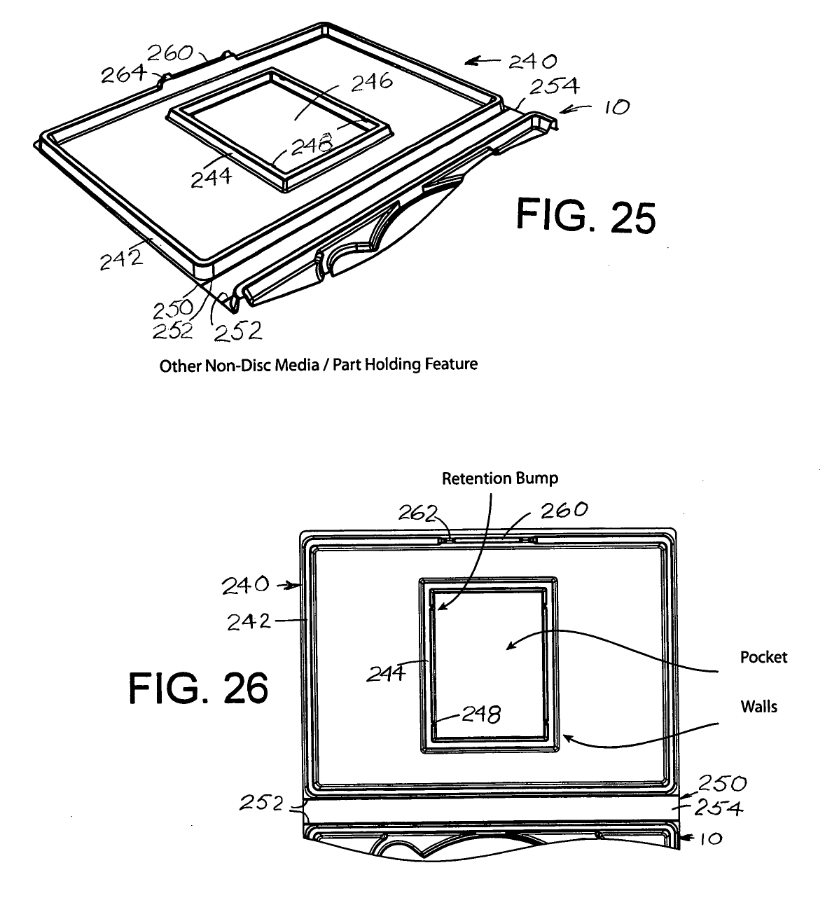

FIGS. 25 and 26 show a second thermoformed tray 240 which is attached to a cover 250. The thermoformed tray 240 has an outer rim 242. An inner rim 244 is formed around a pocket 246 in the center of the tray 240. Inward extending retention bumps 248 hold a booklet or literature in the pocket.

The cover 250 is formed from a coated fibrous sheet such as paperboard or card stock, printed on its outer side or both inner and outer sides and creased 252 to form a spine 254 between the disc holding tray 10 and the booklet holding tray 240.

A male coupling feature 260 is formed on the outer rim 242 of the booklet tray 240. Two sloped outer guides 264 on the extension engage complementary recesses in an opposite disc tray when the cover is closed.

The tray package can be made from virgin PET as well as RPET. The package can be made by heat sealing or gluing a thermoformed PLA or PLH tray to a PLA coated board in order to create a fully biodegradable package. An advantage the new composite package has is it is currently easier to thermoform such bio-plastics than it is to injection mold them.

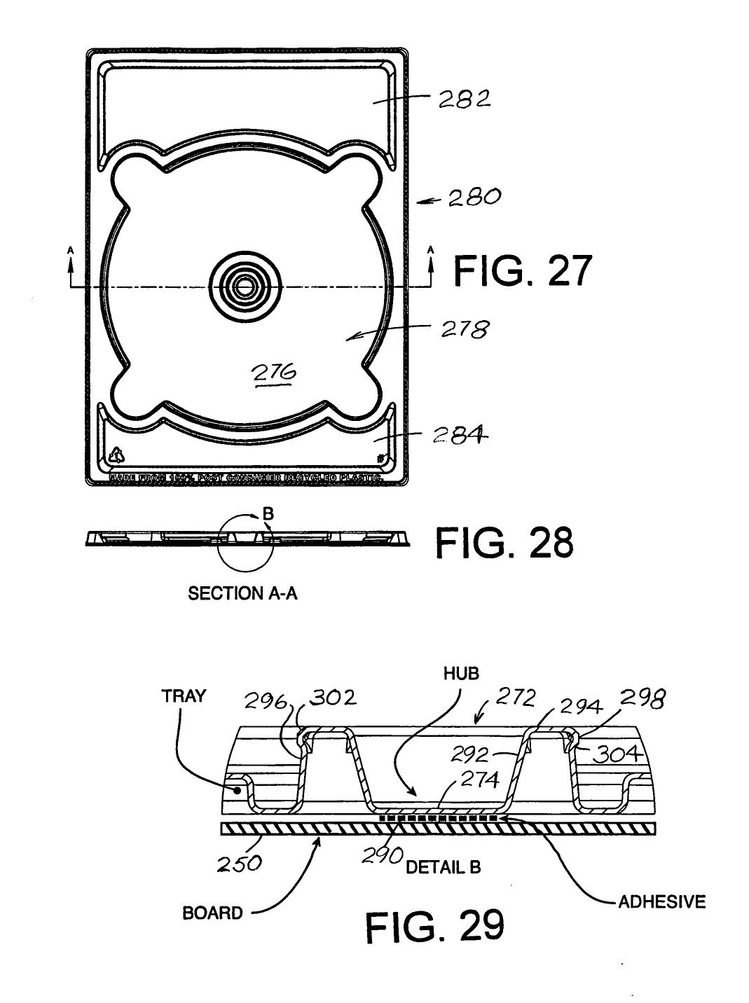

FIGS. 27-29 show a top view, an end cross section and a detail of the tray center and its attachment to a board.

In this case, the center 274 of the hub 272 is flat and is aligned with the bottom 271 of the tray 10 and the bottom 276 of the disc holding well 278. The bottom 276 of the disc holding well or spots on the bottom may be coated with adhesive 290 for attachment to the paperboard cover 250. Areas 282, 284 around the disc-receiving well 278 are flat. Areas 282 and 284 may be open and devoid of material, to reduce weight and consumption of material. When areas 282, 284 are flat, depressed and even with the bottom 276 of the well 278, strips or spots of adhesive 290 may be added beneath the flat areas to hold the tray 280 close to an underlying paperboard 250. Adhesive 290 on the flat center 274 is sufficient to hold the tray 280 on the paperboard.

The sloping side walls 292 between the low center 274 and top 294 of the hub 272 allow the outer wall 296 and the bumps 298 to flex inward as a disc is pressed onto the hub. Sloping walls 302 of the bumps 298 encourage alignment and centering of the disc during placement and assist inward movement of the outer walls 296 so that the bumps snap past the central hole in the disc. The small sloped lower walls 304 of the bumps 298 encourage flexing of the bumps and walls 296 and 292 radially inward while the disc is being lifted from the well while holding outer edges of the disc.

The new thermoformed thin sheet trays reduce materials with which the trays are made and provide operational features which are easy and sure.

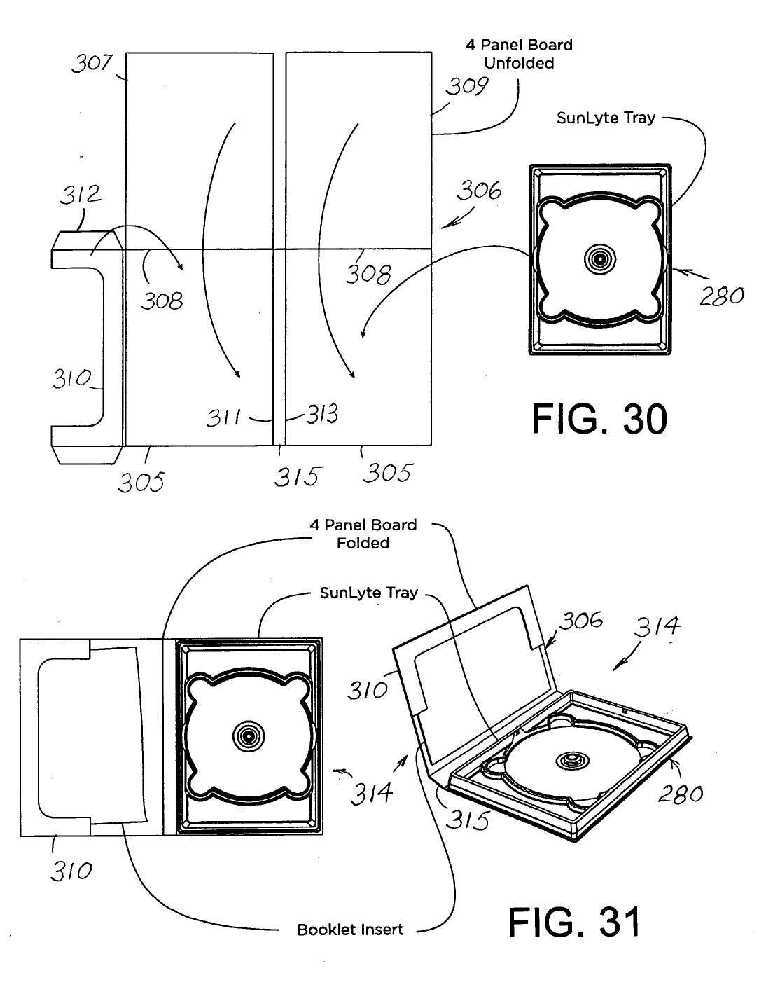

FIG. 30 shows assembly of a panel board cover and attachment glued to insides of outer panels 305 of a tray on a panel board cover. A four panel board blank 306 has its top panels 307,309 folded down along creases 308. The outer panels 305 have inward creases 311 and 313, which form from the spine or web 315 between the folds 311 and 313. Flaps 312 on booklet holder 310 are folded inward, and the booklet holder is folded inward. The flaps are glued and secured to the inner side of the panel board 307 to hold a booklet. Then the tray 280 is secured to the inner side of the panel 309 and the finished product, case 314, results.

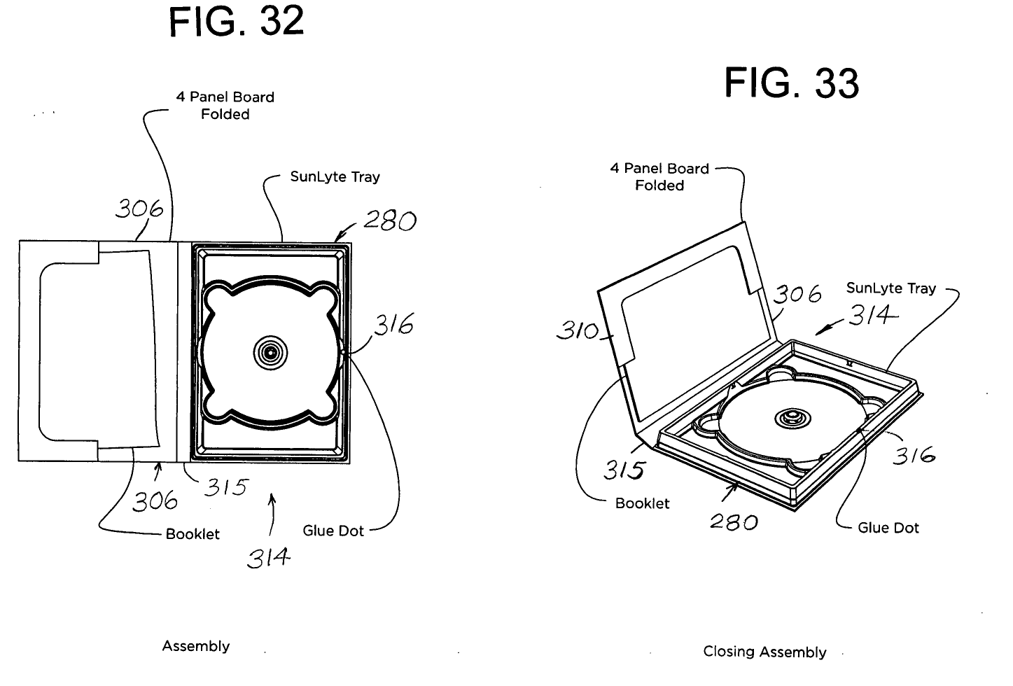

To keep the package closed a small amount of tack adhesive, a glue dot, can be used. FIGS. 32 and 33 illustrate the addition of a glue dot 316 to the finished tray and case product 314. The adhesive 316 can be applied to the edge of the tray 280, or can be centered on the book holder 310 on the board 306. When the package is closed, the adhesive 316 makes contact with the opposite part, and the package stays closed. When the adhesive is applied to the tray 310, an optional opposite clear coating can be applied to the book holder 310 on board 306 to allow the adhesive to preferentially release from the board. When the adhesive is applied to the book holder 310 on board 306, the optional clear coating can be applied to the board except where the adhesive is being applied, to allow the adhesive to stick to the board and preferentially to release from the tray.

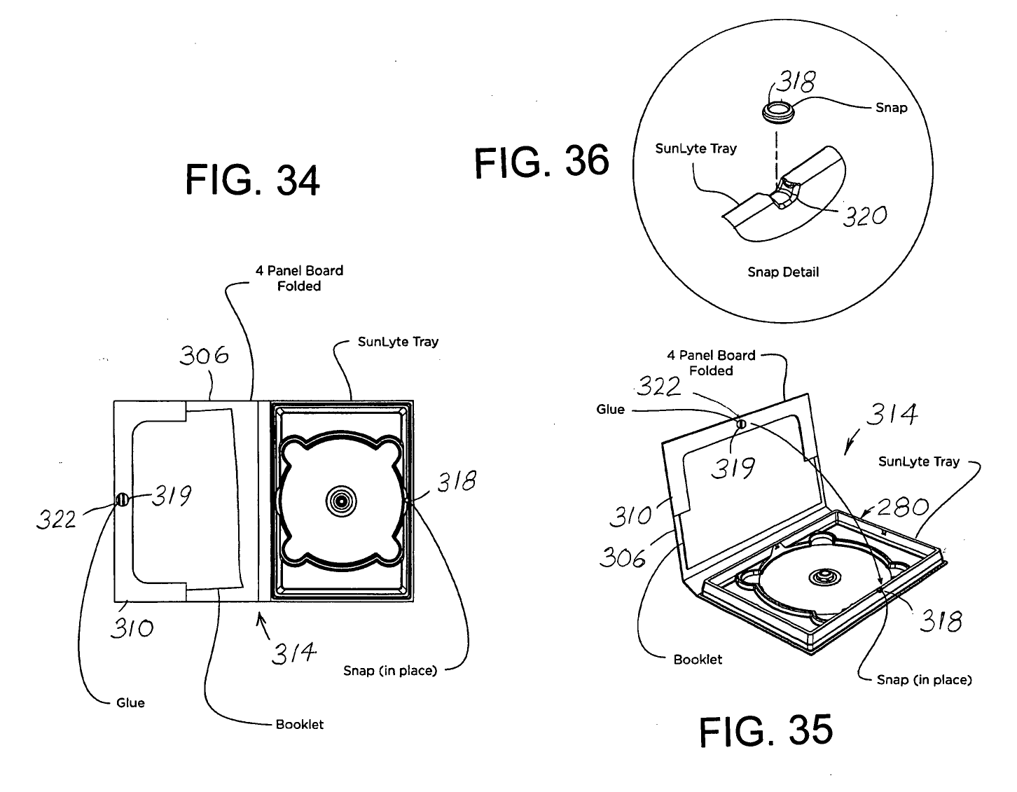

Alternatively, to keep the package closed a snap can be used. FIGS. 34-36 illustrate the addition of snaps 318, 319 to the finished tray product 314. The snap 318 fits into a recess 320 in the tray 280. Adhesive 322 is applied either to the complementary snap 319 or to the center of the book holder 310 on the cover 306. The cover is aligned and closed. This assembly technique insures that the snaps 318, 319 are properly positioned.

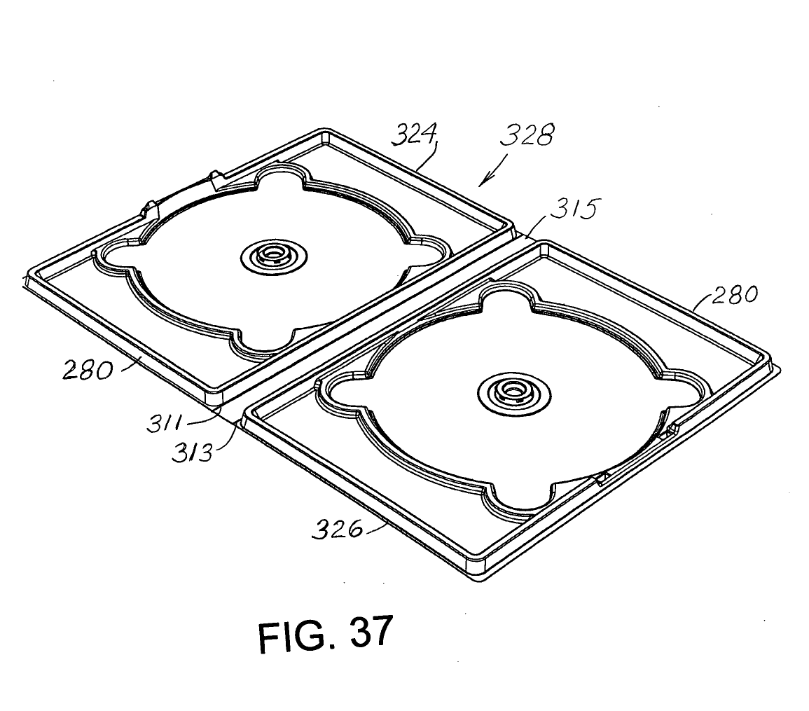

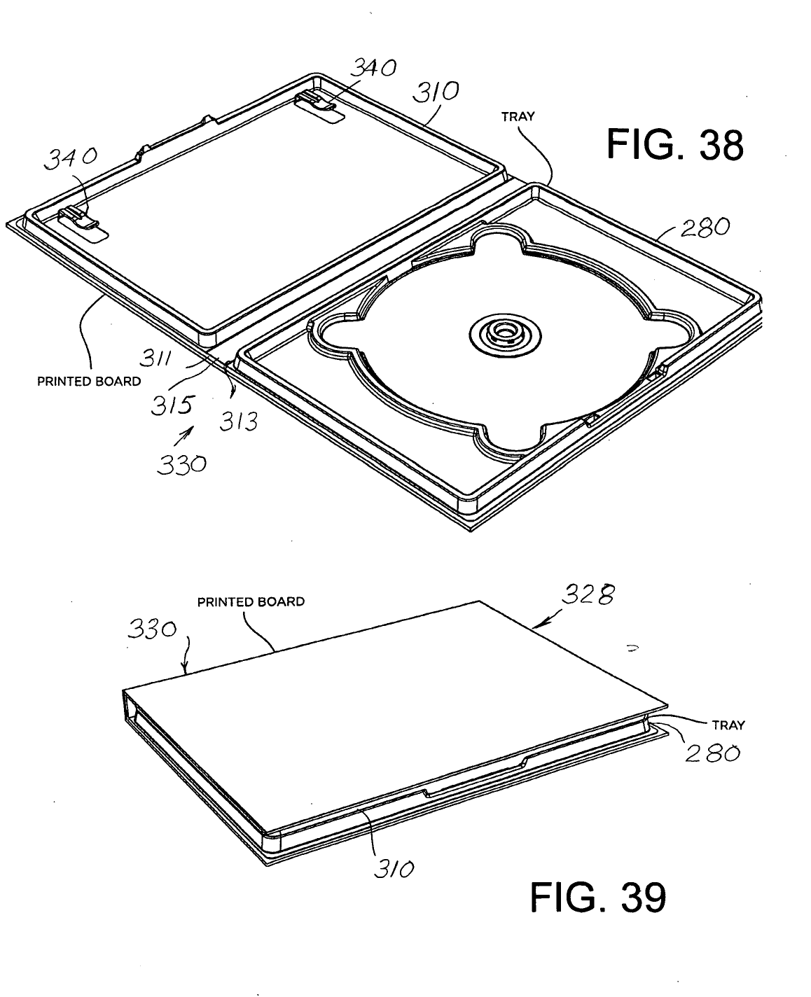

Two versions of the case are a Soft Cover Case and a Hard Paperboard Cover Case. FIG. 37 is a perspective view of a case 328 having two trays 280 with top and bottom segments 324, 326 connected by a web 315. FIGS. 38 and 39 are perspective views of case 330 with literature holding tray 310 having clips 340. Tray 310 is attached to the inner surface of a printed board 307. FIG. 39 shows case 328 or case 330 in a closed position.

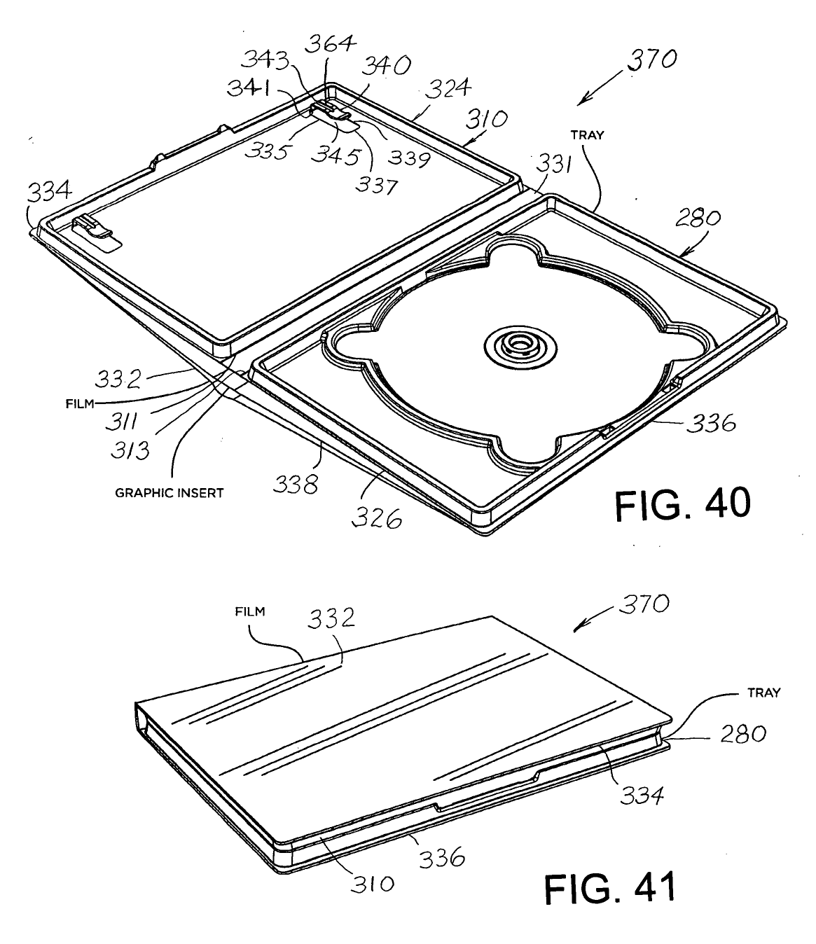

The Soft Cover Case shown in FIGS. 40-43 has top and bottom segments 324, 326 connected by a web 315, also knows as, aka, “the gutter”. The gutter 331 has two or more creases or perforations 311, 313 allowing the segments 324, 326 to hinge along predetermined parallel lines. The gutter 331 separates and is attached to closely adjacent parts of the trays. Gutter 331 may be a film attached to the entire outer flanges which surround the outer surfaces of the trays.

On case 370 shown in FIG. 40, a flexible film 332 is adhered to outer surfaces of flanges on the opposing edges 334, 336 of the trays 310, 280. The film 332 attachment flanges are parallel to the creases 311, 313. A sheet 338 printed on both sides is inserted under the film 332 to add graphics to the outside and inside of the package as viewed through the outer film 332 and through the clear tray 280 and 310. FIG. 40 is a perspective view of case 370 and a tray 280 and 310 with literature clips 340 and with an attached gutter 331 outer film 332 and graphic insert 338, in open position. FIG. 41 shows case 370 closed.

A Hard Paperboard Cover Case also involves a tray with front and back segments 324, 326 connected by a web 331 (aka “the gutter”). The web has three or more creases or perforations 311, 313 allowing the segments to hinge along predetermined parallel lines. A paperboard cover is affixed to the front and back segments 324, 326 of the tray but not to the web. The distance between the creases is such that when the case is open the cover, trays 310, 280 and web 315 lie approximately flat. When the case is closed the additional crease or creases allows the web to collapse so that the web does not interfere with closing.

Literature clips 340 or tabs are formed in thin thermoformed trays 310 for holding literature such as booklets, instructions cards etc. The clips 340 have structures thermoformed with the tray. The clip structures are diecut along three sides 335, 337, 339 of openings and are formed in such a way that, when folded, the clips 340 are folded upward, they can create clearance to insert literature under the clips 340 yet have rigidity for holding the literature in place. Two parallel fold lines 341, 343 across the clips 340 allows the clip structure to be folded upward to create space 345 for the literature. A clip locking pocket and post or similar features can be added or formed on the tray side wall, to increase the clips rigidity by creating a fulcrum. Grooves 364 increase rigidity of the clips.

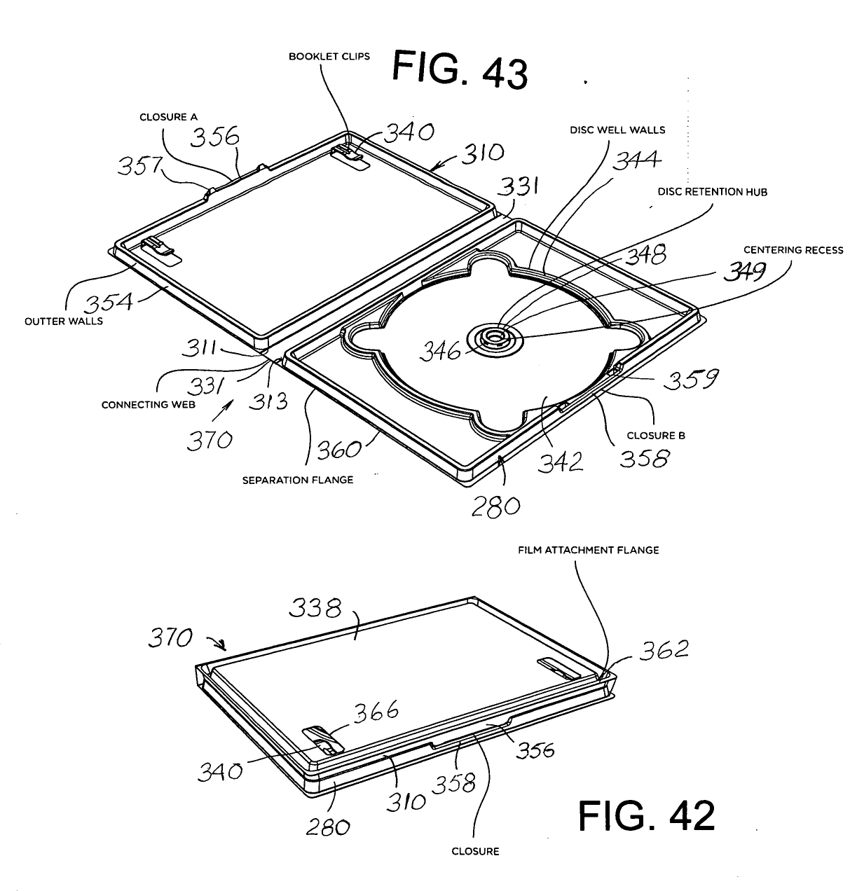

FIGS. 42 and 43 show an assembled tray case 370 before a printed insert is placed between the trays 280, 310 and the plastic film 338. The printed insert is printed on both sides so that graphics are visible on the outer surfaces through film 338 as well as through the transparent trays 280, 310. Literature clips 340 are visible through openings 366 and through the transparent film cover 338 in FIG. 42. The tray 280 as shown in FIG. 43 has a disc well 342 with disc well walls 344 and disc retention bumps 346 on centering hub 348, with a centering recess 349. The thermoformed booklet holding tray 310 with booklet clips 340 is connected to the tray 280 by a connecting web 331 with creases or perforations 311, 313. Outer walls 354 of the opposing trays 280, 310 close the interior of the case. Closure 356 and tabs 357 cooperate respectively with recess 358 and receivers 359 in tray 280 to hold the case 370 in the closed position shown in FIG. 42. Separation flange 360 surrounding the outer walls 354 aid in separation of stacked trays during assembly. Film attachment flanges 362 provide attachment of the outer film 338 to the trays for the soft cover case 370.

An advantage of the soft cover case is that cases may be made in advance and paper inserts may be printed and placed according to the contents of the case.

While the invention has been described with reference to specific embodiments, modifications and variations of the invention may be constructed without departing from the scope of the invention, which is defined in the following claims.

We claim:

1. A disc package, comprising a thermoformed plastic tray formed for holding a disc adhered to a cover.

2. The disc package of claim 1, wherein the thermoformed tray and the cover is a paperboard cover are constructed in sizes to hold CD, DVD, HD and Blue Ray discs.

3. The disc package of claim 1, wherein the tray is thermoformed from RPET from flaked beverage bottles which have been flaked, melted and extruded in sheets and films.

4. The disc package of claim 1, wherein the tray is compliance and has a robust central disc holder.

5. The disc package of claim 4, further comprising a tapered recess in the disc holder for accurate positioning of a disc when the tray is adhered to the cover.

6. The disc package of claim 1, wherein the tray has side walls and a rim extends outward from the side walls to provide separation of an individual tray from a stack of trays before adhering the tray on the cover.

7. The disc package of claim 1, wherein the tray has a disc receiver with a flat bottom surface contacting the cover and providing clarity and appearance of graphics on the printed cover visible through the bottom surface of the tray.

8. The disc package of claim 1, wherein the tray has a center disc holder hub undercut which provides an interference fit with disc holder hubs of adjacent trays in a stack of trays for limiting nesting and spacing adjacent stacked trays for easier separation of the tray from the stack when placing the tray in the printed cover.

9. The disc package of claim 1, wherein the cover is a printed paperboard cover and the tray has a central disc holder hub with a flat bottom the thermoformed tray is adhered to the printed paperboard cover by bonding a flat bottom of a central disc holder hub on the tray to the paperboard cover.

10. The disc package of claim 1, wherein the thermoformed tray has an outer side wall and a rim extending outward from the side wall, a disc-receiving recess with bottom and finger grooves extending from the recess, an outer raised area extending inward from the outer side wall and an inner raised area around the disc-receiving recess, and flat bottom areas between the outer and inner raised areas and an outer rib and an inner rib extended upward from outer and inner portions of the disc-receiving recess for holding recorded information portions of a disc spaced from the flat bottom of the disc recess.

11. A package for holding one or more discs or other products, comprising one or more thermoformed trays with product retention receivers and retainers adhered to a paperboard cover configured to hold one or more trays, a joint between the one or more trays having two or more creases near a center to allow the cover to folded closed or be opened flat.

12. The package of claim 11, wherein the one or more thermoformed trays are made from recycled PET from beverage bottles.

13. The package of claim 11, wherein the retainers in the one or more thermoformed trays are formed into the tray by undercuts that hold discs or other products in the tray.

14. The package of claim 11, wherein the one or more thermoformed trays have flanges projecting outward from sides of the trays to allow easy separation of the trays when nested in stacks of two or more trays.

15. The package of claim 11, wherein the one or more thermoformed trays have a raised center hub or other product-holding shape, with one or more protrusions to limit a distance trays can nest when stacked.

16. The process of forming a disc package, comprising forming a thermoplastic sheet into a tray by heat, vacuum, pressure, or vacuum and pressure, and forming raised surfaces to protect a disc, forming a compliant disc-holding hub by forming a center of the sheet with negative undercuts and stretching and pulled the form sheet to remove from sheet formers.

17. The process of claim 16, further comprising initially melting plastic flakes from comminuted beverage and water bottles, melting the flakes and extruding the melt into the thermoplastic sheet, and die cutting the formed tray from the sheet.

18. The process of claim 16, further comprising printing a paperboard, clear coating the printed paperboard, die cutting and creasing the printed and coated paperboard, and adhering the thermoformed tray to the paperboard.

19. The process of claim 18, wherein the adhering further comprises adhering the thermoformed tray to the coated paperboard with a tack adhesive for allowing the tray to be removed from the printed paperboard for recycling.

20. The process of claim 18, further comprising a booklet-holding thermoformed tray attached to the paperboard cover opposite a disc-holding thermoformed plastic tray, the booklet-holding tray having outer walls with a rim extending from the outer walls, an outer raised surface area extending inward from the outer walls, an inner flat bottom extending inward from an outer flat bottom adjacent the paperboard cover, a rectangular inner raised area and an inner flat bottom extending inward from the inner raised area, and bumps extending inward from the inner raised area for holding a booklet between the bumps and the inner flat bottom.

21. The process of claim 16, further comprising forming holding features over a male form that has one or more bumps on its outer surface, pulling the formed tray part off the male form, and stretching the material to be released from the male form, wherein a size of the bumps in the tray is equal to a size of the bumps on the male form plus thickness of the formed sheet, less material shrinkage due to the change in material temperature from the forming temperature to ambient temperature.

22. The process of claim 16, further comprising forming holding features by forming the tray in a female form that has the bumps in relief on its internal surface, pulling the tray off the main female form, and compressing material to be released from the female form undercut, wherein a size of bumps in the formed tray is equal to a size of the bumps in the female form, less material shrinkage due to the change in material temperature from the forming temperature to the ambient temperature.

23. The process of claim 16, further comprising forming holding features by forming over a male form with retractable features, after the forming of the bumps, and retracting the features for allowing removal of the undercuts.

24. The process of claim 16, further comprising forming holding features by mechanically cold-forming or hot-forming the center hub with a tool, wherein the size of the bumps is dependent upon the amount of mechanical deformation applied.

25. The process of claim 16, further comprising printing, cutting, folding and creasing paperboard to create package covers, and adhering one or more product-holding trays to the printed paperboard covers such that the paperboard cover can be opened flat or folded into a closed package.

26. The process of claim 16, further comprising making a package where beverage bottles made from PET are cleaned, ground, melted and extruded into thin rolls of sheet film and thermoformed into the trays for holding discs and other products using product retention features.

27. The package of claim 11, further comprising a small amount of tack adhesive applied to an edge of one of the trays or the paperboard cover, so that when the package is folded the adhesive makes contact and the package stays closed.

28. The package of claim 27, further comprising a clear coating applied to the paperboard, wherein if the tack adhesive is applied to the paperboard, the clear coating is applied to the paperboard except where the tack adhesive is applied, to allow the adhesive to preferentially release from the board or to stick to the board and preferentially release from the tray.

29. The package of claim 11, further comprising a recess in one of the trays and a first snap in the recess and adhesive applied to a complementary snap or to the paperboard cover for attaching the complementary snap to the paperboard cover.

30. A package for holding one or more discs or other products, comprising two thermoformed trays with product retention receivers and retainers and front and back segments the two trays connected by a web with two or more creases or perforations allowing the trays to hinge along predetermined parallel lines.

31. The package of claim 31, further comprising a flexible film adhered to opposite edges of the trays parallel to the two or more creases and a graphic insert between under the film and the trays to add graphics to an outside and an inside of the package as viewed through the film and through the trays.

32. The package of claim 30, further comprising paperboard cover portions affixed to the trays but not to the web, wherein the web has three or more creases or perforations, wherein the distance between the creases or perforations is such that, when the package is open, the cover, trays, and web lie approximately flat, and wherein when the case is closed the creases allow the web to collapse so that the web does not interfere with closing.

33. The package of claim 30, further comprising literature clips thermoformed into one of the trays, wherein the trays having openings are diecut along three sides forming literature clips with two parallel lines across the clips, wherein the clip structure is folded along the parallel lines to create clearance to insert literature under the clips and have rigidity for holding the literature in place.

34. The package of claim 33, further comprising a clip locking pocket and post or similar features to increase rigidity of the clips by creating a fulcrum.

35. The package of claim 30 wherein the trays are made from ground PET bottle flakes, which are melted, extruded and thermoformed into the trays.

36. The package of claim 30 wherein the trays are made from at least 10% ground PET bottle flakes, which are melted, extruded and thermoformed into the trays.

37. Disc holding trays made from ground PET bottle flakes, which are melted, extruded and thermoformed into the trays.
